(19) United States
(12) Patent Application Publication
(10) Pub. No.: US 2019/0305441 A1
(43) Pub. Date: Oct. 3, 2019

(54) CRIMPING TOOL AND TERMINAL OBTAINED WITH THE TOOL

(71) Applicant: Aptiv Technologies linited, St. Michael (BB)

(72) Inventor: Houssem Eddine Miled, Ivry-Sur-Seine (FR)

(21) Appl. No.: 16/316,496

(22) PCT Filed: Jul. 17, 2017
(86) PCT No.: PCT/EP2017/068062

§ 371 Date: Jan. 9, 2019

(30) Foreign Application Priority Data
Jul. 19, 2016 (FR) 1656885

(51) Int. Cl. H01R 4/18; H01R 4/62; H01R 43/048

(52) U.S. Cl. CPC H01R 4/185; H01R 43/048; H01R 4/62

(57) ABSTRACT

A crimping tool includes a crimping section extending in a longitudinal direction having a crimping punch part and a crimping anvil part. The punch part is provided with a first punch element and a second punch element adjacent to the first element. The anvil part is provided with a first crimping anvil element and a second crimping anvil element. The first and the second punch elements respectively comprise first and second grooves. The first punch element having a groove depth greater than the groove depth of the second punch element, so as to form a downward punch step from the first groove to the second groove. The first and second anvil elements respectively comprise first and second crimping surfaces. The second crimping surface is raised relative to the first crimping surface so as to form an upward anvil step.

### CROSS-REFERENCE TO RELATED APPLICATIONS

This application is a national stage application under 35 U.S.C. § 371 of PCT Application Number PCT/EP2017/068062 having an international filing date of Jul. 17, 2017, which designated the United States and claimed priority under Article 8 of the Patent Cooperation Treaty to Application 1656885 filed in the Institut National de la Propriété Industrielle (French Patent Office) on Jul. 19, 2016, the entire disclosure of each of which is hereby incorporated herein by reference.

### TECHNICAL FIELD OF THE INVENTION

The invention relates to a method of crimping an electrical terminal onto an electrical cable, and more particularly to the crimping tool and to the electrical terminal obtained after the crimping operation.

### BACKGROUND OF THE INVENTION

To reduce the weight of the electrical wiring looms in vehicles, copper cables are sometimes replaced with aluminium cables including a plurality of conductive strands. Replacing copper cables with aluminium cables causes a number of problems. Primarily, aluminium becoming covered with a layer of oxide, electrical conduction at the level of the areas of contact between an aluminium cable and a copper terminal can be reduced. In order to alleviate this problem the aim is, on the one hand, to break up the oxide layer to have better conductivity and, on the other hand, to prevent this oxide layer being formed again after crimping. To this end, the compression ratio of the cable may be increased in the crimping zone. However, this increase in the compression ratio causes a reduction of the mechanical strength of the cable in the area compressed in this way.

It is known to crimp the crimping zone onto the cable by bending and compressing the lugs onto the cable using for this purpose a tool including a punch with two different crimped heights. There is then obtained, after crimping, a crimping zone that comprises a mechanical retention portion and an electrical conduction portion. The mechanical retention and electrical conduction portions are in continuity of material with one another. In other words, starting from a terminal with a single lug on each side of the cable, with no cut-out in these lugs or no slot separating them into a plurality of portions, there is obtained a crimping tang that is continuous in the longitudinal direction. The mechanical retention and electrical conduction portions have different final crimped heights, the final crimped height of the mechanical retention portion being greater than the final crimped height of the electrical conduction portion.

The strands of the cable are therefore less compressed in the mechanical retention zone. The integrity of their mechanical properties is therefore essentially preserved and the retention of the cable in the crimping tang satisfies the specifications. In the electrical conduction zone, the strands of the cable are compressed more, the mechanical properties there being therefore degraded compared to the mechanical retention zone. On the other hand, the electrical resistivity in the electrical conduction zone is lower than in the mechanical retention zone.

However, it is seen that the electrical and mechanical properties of crimped terminals using this type of method degrade over time.

The present invention aims to propose a new solution enabling these problems to be solved in an economic, easy and reliable manner.

### SUMMARY OF THE INVENTION

A crimping tool for executing a method of crimping an electrical terminal including a crimping section extending in a longitudinal direction comprises a crimping punch part and a crimping anvil part; the punch part is provided with a first punch element and a longitudinally aligned second punch element adjacent to the first element; the anvil part is provided with a first crimping anvil element and a second crimping anvil element arranged to face the first punch element and the second punch element, respectively; the first punch element cooperating with the first anvil element forms a first crimping element; the second punch element cooperating with the second anvil element forms a second crimping element; the first and the second punch elements respectively comprise longitudinally aligned first and second grooves, the first punch element having a groove depth greater than the groove depth of the second punch element, so as to form a downward step of the punch from the first groove to the second groove; the first and second anvil elements respectively comprising first and second crimping surfaces, the first and second surfaces being aligned longitudinally; the second crimping surface being raised relative to the first crimping surface so as to form an upward anvil step from the first crimping surface to the second crimping surface.

The crimped height of the second crimping element can be 10% to 60% less than the crimped height of the first crimping element, preferably less than 30% to 50%. The height of the upward anvil step can be between 0.4 times and 1.6 times inclusive the height of the downward punch step, preferably between 0.8 times and 1.2 times inclusive. The height of the downward punch step added to the height of the upward anvil step can be between 0.1 mm and 0.7 mm inclusive.

A method according to the invention of crimping an electrical terminal comprises the steps of:
furnishing an electrical cable comprising insulation and conductive strands;
furnishing an electrical terminal comprising a crimping section extending along a longitudinal axis, said section comprising a longitudinal tang and two lugs each extending from one side of the tang to form a groove having essentially a U-shape in section in a plane perpendicular to the longitudinal direction;
longitudinally positioning the conductive strands of the cable in the crimping section of the electrical terminal;
crimping the mechanical retention portion of the crimping section adjacent to the insulation of the cable; and
crimping the electrical conduction portion of the crimping section by bending and compressing the lugs onto the free end of the conductive strands and compressing the bottom of the tang onto the free end of the conductive strands, so as to obtain greater compression on the free end of the conductive strands than the compression exerted by the mechanical retention portion on the conductive strands, so as to form a downward terminal step from the bent portion of the lugs of the mechanical retention portion to the bent portion of the lugs of the electrical conduction portion, and so as to form an upward terminal step from the portion of the tang of the mechanical retention portion to the portion of the tang of the electrical conduction portion.

The crimping steps can produce a compression ratio in the electrical conduction portion between 45% and 65% inclusive, preferably between 50% and 60% inclusive and a compression ratio in the mechanical retention portion between 15% and 40% inclusive, preferably between 20% and 30% inclusive. The step of crimping the electrical conduction portion can form the upward step with a height between 0.4 times and 1.6 times inclusive the height of the downward step, preferably between 0.8 times and 1.2 times inclusive. The crimping steps can comprise the crimping tool described above.

An electrical terminal crimped onto the conductive strands of an electrical cable by the crimping method described above is characterised in that the bottom of the longitudinal tang comprises an upward terminal step forming a transition between the mechanical retention portion of the crimping zone and the electrical conduction portion of the crimping zone, and in that: the free ends of the bent lugs of the crimping zone comprise a downward terminal step forming a transition between the mechanical retention portion of the crimping zone and the electrical conduction portion of the crimping zone.

The upward step can have a height between 0.4 times and 1.6 times inclusive the height of the downward step, preferably between 0.8 times and 1.2 times inclusive. The upward step and the downward step can be globally aligned in the vertical direction. The height of the downward step added to the height of the upward step can be between 0.1 mm and 0.7 mm inclusive.

### BRIEF DESCRIPTION OF THE SEVERAL VIEWS OF THE DRAWING

Other features, objects and advantages of the invention will become apparent on reading the following detailed description with reference to the appended drawings, provided by way of nonlimiting example and in which:

FIG. 1 is a diagrammatic perspective view of an example of an electrical terminal that has not yet been crimped onto an electrical cable;

FIG. 2 is a diagrammatic perspective view of a crimping tool comprising first and second crimping elements;

FIG. 3 is a diagrammatic perspective view of the crimping tool from FIG. 2 ready to crimp the crimping zone of the terminal from FIG. 1 comprising the conductive strands of the electrical cable;

FIG. 4 is a front view of the crimping tool from FIG. 3;

FIG. 5 is a diagrammatic perspective view of the crimping tool from FIG. 2 when the tool crimps the crimping zone of the terminal from FIG. 1;

FIG. 6 is a diagrammatic view in cross section taken along the line 6-6 in FIG. 5 that shows the crimping zone produced at the level of the first crimping element;

FIG. 7 is a diagrammatic view in cross section taken along the line 7-7 in FIG. 5 that shows the crimping zone produced at the level of the second crimping element;

FIG. 8 shows in lateral elevation the crimping zone of the terminal from FIG. 1 after crimping onto the conductive strands of the cable; and

FIG. 9 is a diagrammatic view in longitudinal section of the crimping zone from FIG. 8.

### DETAILED DESCRIPTION OF THE INVENTION

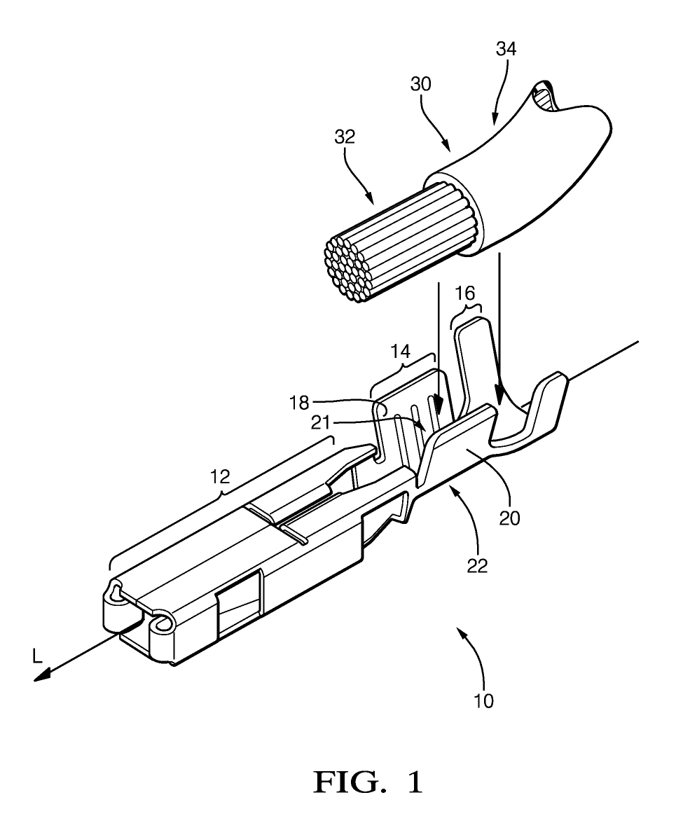

FIG. 1 shows an electrical terminal 10 intended to be mounted in a motor vehicle connector cavity (not shown). In the situation represented, this is a straight female terminal 10 extending in a longitudinal direction L. In other situations, not shown, the electrical terminal 10 may be a right-angle terminal for example.

The electrical terminal 10 has a coupling portion 12, a zone 14 to be crimped onto the conductive strands 32 of an electrical cable 30 and a crimping end 16 to be crimped onto the insulation 34 of the electrical cable 30. In the situation shown in FIG. 1, the coupling portion 12, the crimping zone 14 and the crimping end 16 follow on in succession in the longitudinal direction L.

Before crimping, the crimping zone 14 is in the form of a trough with two crimping lugs 18, 20 each extending from one side of a crimping tang 22. Before crimping, the two crimping 18, 20 and the crimping tang 22 therefore form a groove 21 essentially having a U-shape in section in a plane perpendicular to the longitudinal direction L. Each crimping lug 18, 20 is continuous over all its length. In other words, each crimping lug 18, 20 includes neither slots nor cut-outs.

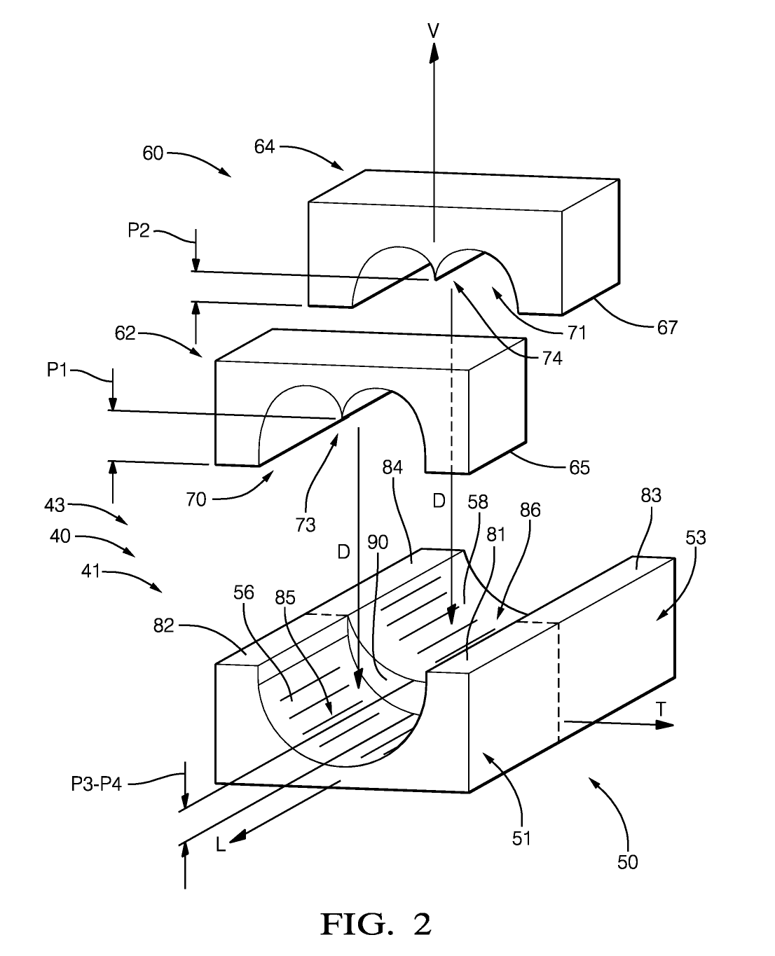

The electrical terminal 10 undergoes an operation of crimping it onto the electrical cable 30 during which the crimping lugs 18, 20 are bent and compressed onto the conductive strands 32. This crimping operation is carried out with the conductive strands 32 of the electrical cable 30 inserted in the groove 21 of the crimping zone 14 and by striking the electrical terminal 10 at the level of the crimping zone 14 between an anvil part 50 and a crimping punch part 60 of a crimping tool 40 shown in FIG. 2.

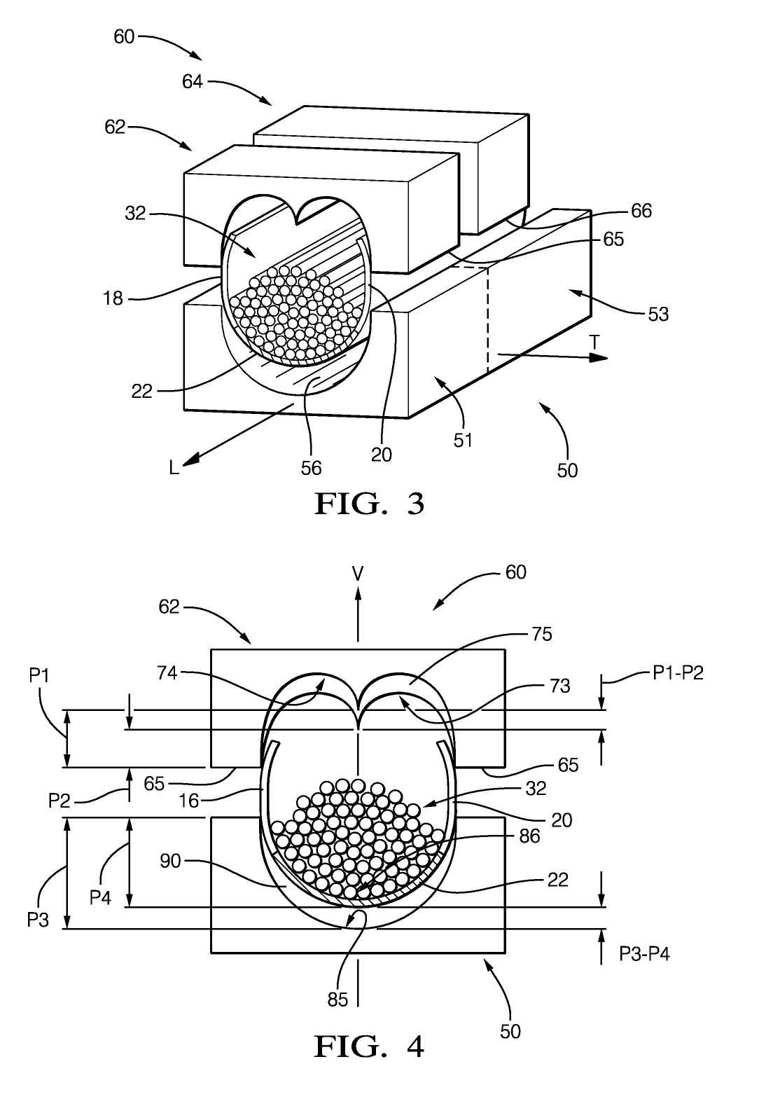

FIG. 2 shows one embodiment of the crimping tool 40 according to the invention. FIG. 3 shows the crimping tool 40 in which is placed the crimping zone 14 of the electrical terminal 10 comprising the conductive strands 32 of the electrical cable 30. In FIGS. 2 and 3, this crimping tool 40 includes the anvil part 50 designed to have placed longitudinally therein the crimping zone 14 of the electrical terminal 10. The crimping tool 40 also comprises the crimping punch part 60 enabling bending and compression of the crimping lugs 18, 20 of the crimping zone 14 of the electrical terminal 10 onto the conductive strands 32 of the electrical cable 30.

The crimping punch part 60 comprises first and second punch elements 62, 64. Each punch element 62, 64 is of parallelepiped overall shape. Each punch element 62, 64 comprises a planar base 65, 67 adapted to strike the anvil part 50 in a direction D perpendicular to the longitudinal axis L during the movement of each punch element 62, 64 during a crimping operation. Each base 65, 67 is designated as the bottom part of each punch element 62, 64. Each base 65, 67 includes two teeth 66, 68 separated by a notch 70, 71.

Each notch 70, 71 extends longitudinally on either side of each punch element 62, 64. Each notch 70, 71 corresponds to the part of each punch element 62, 64 enabling shaping of the crimping lugs 18, 20 of the crimping zone 14 of the electrical terminal 10. Each notch 70, 71 includes from each base 65, 67 to the top part of each punch element 62, 64 facing walls to receive the crimping lugs 18, 20 of the electrical terminal 10.

Each wall extends toward a punch groove 73, 74 essentially in the form of two arches joined side-by-side and resembling an ‘M’ in section in a plane perpendicular to the longitudinal direction L. Each punch groove 73, 74 enables the crimping lugs 18, 20 to be moved progressively over the conductive strands 32 of the electrical cable 30 followed by compression of the two crimping lugs 18, 20 on top of the conductive strands 32 of the electrical cable 30. The geometrical shapes of the first and second punch elements 62, 64, including the shape of their punch grooves 73, 74 and the length along the longitudinal axis of the first and second punch grooves 73, 74, are substantially identical.

However, the first punch element 62 differs essentially from the second punch element 64 by the depth P1 of the first punch groove 73. By punch groove depth is meant the distance along the vertical axis V between the first punch groove 73 and the base 65 of the punch element 62. The first punch element 62 is that having a groove depth P1 greater than the second punch element 64. As shown in FIG. 2, the punch groove depth P1 of the first punch element 62 is greater than the punch groove depth P2 of the second punch element 64.

As shown in FIG. 4, when the bases 65, 67 of the punch elements are adjacent and aligned longitudinally, the difference between the depth P1 of the first punch element 62 and the depth P2 of the second punch element 64 forms a downward punch step 75 from the first punch groove 73 of the first punch element 62 to the second punch groove 74 of the second punch element 64.

In FIG. 2, the anvil part 50 comprises first and second anvil elements 51, 53. In the embodiment shown, the first and second anvil elements 51, 53 are made in one piece. The first anvil element 51 and the second anvil element 53 are the counterparts of the first punch element 62 and the second punch element 64, respectively, each punch element 62, 64 coming to strike its respective anvil element 51, 53 during the operation of crimping the conductive strands 32 of the electrical cable 30.

The first and second anvil elements 51, 53 respectively comprise first and second concave crimping surfaces 56, 58 essentially of circular arc profile in section in a plane perpendicular to the longitudinal direction L. In other words, each crimping surface 56, 58 forms an anvil groove 85, 86 essentially of circular arc shape or of arch shape resembling a IT in section in a plane perpendicular to the longitudinal direction L. Each crimping surface 56, 58 extends in the longitudinal direction so as to receive the crimping tang 22 of the crimping zone 14 of the electrical terminal 10 comprising the conductive strands 32 of the electrical cable 30. In the embodiment shown, the electrical shape of the first crimping surface 56 is similar to the geometrical shape of the second crimping surface 58, in other words the radius of the circular arc profile of the first crimping surface 56 is identical to the radius of the circular arc profile of the second crimping surface 58.

Each anvil groove 85, 86 comprises on each side a plane rim extending longitudinally along each groove. In other words, each anvil element 51, 53 comprises a first plane rim 81, 83 and a second plane rim 82, 84 extending in a longitudinal plane on either side of each crimping surface 56, 58. The first plane rims 81, 83 and the second plane rims 82, 84 of the first and second anvil elements 51, 53 are the parts that come to be struck by the teeth 66, 68 of the bases of each punch element 62, 64 during a crimping operation. The first plane rims 81, 83 and the second plane rims 82, 84 of the first and second anvil elements 51, 53 are in the same longitudinal plane.

The geometrical shapes of the first and second anvil elements 51, 53, including the shape of their crimping surface 56, 58 and the length along the longitudinal axis of their crimping surface, are substantially identical. However, the first anvil element 51 essentially differs from the second anvil element 53 by its depth P3 of the first anvil groove 85. By anvil groove depth is meant the distance along the vertical axis V separating the bottom of the anvil groove from a plane rim. The first anvil element 51 is that having a depth P3 of the first anvil groove 85 greater than the second anvil element 53. As shown in FIG. 4, the anvil groove depth P3 of the first anvil element 51 is greater than the anvil groove depth P4 of the second anvil element 53.

As shown in FIG. 4, when the first plane rim 81 and the second plane rim 82 of the first anvil element 51 are adjacent and aligned longitudinally with the first plane rim 83 and the second plane rim 84 of the second anvil element 53, the difference between the anvil groove depth P3 of the first anvil element 51 and the anvil groove depth P4 of the second anvil element 53 forms an upward anvil step 90 from the first anvil groove 85 of the first anvil element 51 to the second anvil groove 86 of the second anvil element 53. In other words, the crimping surface 58 of the second anvil element 53 is raised relative to the crimping surface 56 of the first anvil element 51.

Although shown in one piece, the first anvil element 51 and the second anvil element 53 can be two independent pieces. Similarly, although shown as two independent pieces, the first punch element 62 and the second punch element 64 can be in one piece.

The first punch element 62 associated with the first anvil element 51 forms a first crimping element 41. The second punch element 64 associated with the second anvil element 53 forms a second crimping element 43.

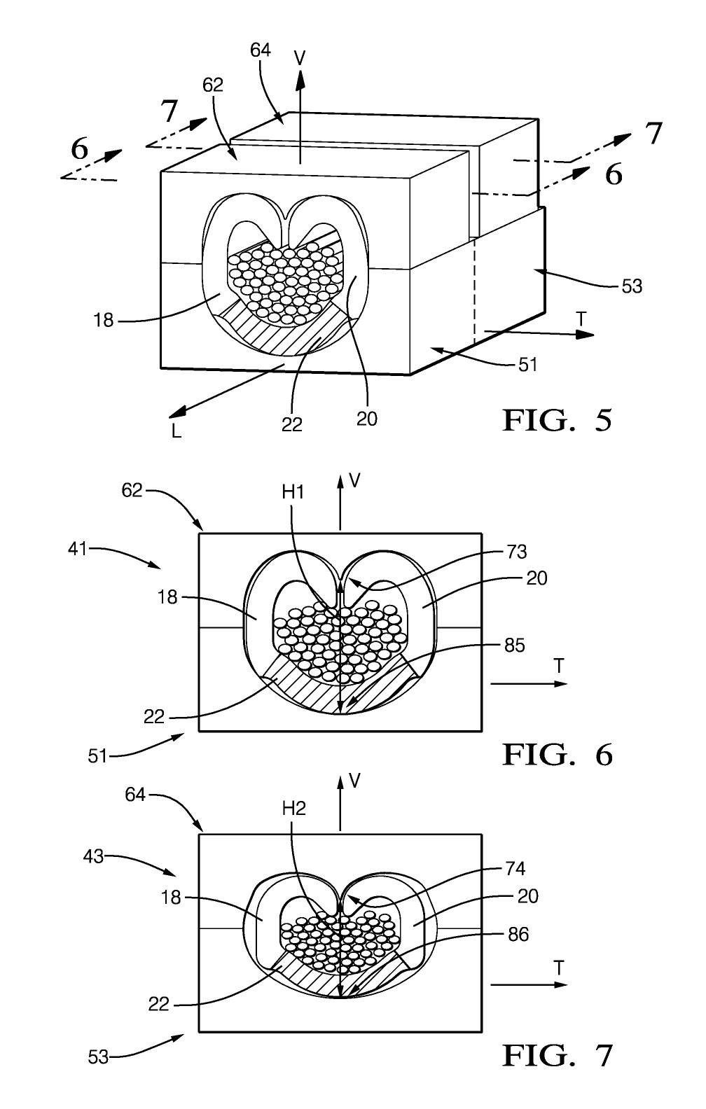

In FIGS. 5 and 6, when the first punch element 62 strikes the first anvil element 51, a first portion of the crimping lugs 18, 20 of the crimping zone 14 has been bent and compressed onto the conductive strands 32 of the electrical cable 30. A first portion of the crimping tang 22 also comes to compress the conductive strands 32 of the electrical cable 30. The distance along the vertical axis V measured between the bottom of the first groove 85 of the first anvil element 51 and the bottom of the first punch groove 73 of the first punch element 62 defines a first crimped height H1 of the conductive strands 32.

In FIGS. 5 and 7, when the second punch element 64 strikes the second anvil element 53, a second portion of the crimping lugs 18, 20 of the crimping zone 14 has been bent and compressed onto the conductive strands 32 of the electrical cable 30. A second portion of the crimping tang 22 also comes to compress the conductive strands 32 of the electrical cable 30. The distance along the vertical axis V measured between the bottom of the second anvil groove 86 of the second anvil element 53 and the bottom of the groove 74 of the second punch element 64 defines a second crimped height H2 of the conductive strands 32.

It is to be noted that according to FIGS. 6 and 7, the crimped heights H1, H2 are more precisely measured between the deepest point of the first and second anvil grooves 85, 86 of the first anvil element 51 and the second anvil element 53 and the middle point of the ‘M’ shape of each punch groove 73, 74 of each punch element 62, 64 in section in a plane perpendicular to the longitudinal direction L, that is to say at the points of intersection of the two arches defining the shape of the groove. In order to be able to compare the crimped heights H1, H2, what is important is to produce the measurements in similar frames of reference, namely for example between a middle point of each ‘M’ shape of each punch groove 73, 74 of each punch element 62, 64 and each deepest point of each anvil groove 85, 86 of each anvil element 51, 53.

The crimped heights H1, H2 are therefore found in the crimping zone 14 of the electrical terminal 10 after the crimping operation. They are measured between the bottom of the crimping tang 22 and the point of intersection of the crimping lugs 18, 20 bent onto the conductive strands 32.

In one particular embodiment, the crimped height H2 of the second crimping element 43 is 10% to 60%, preferably 30% to 50% less than the crimped height H1 of the first crimping element 41.

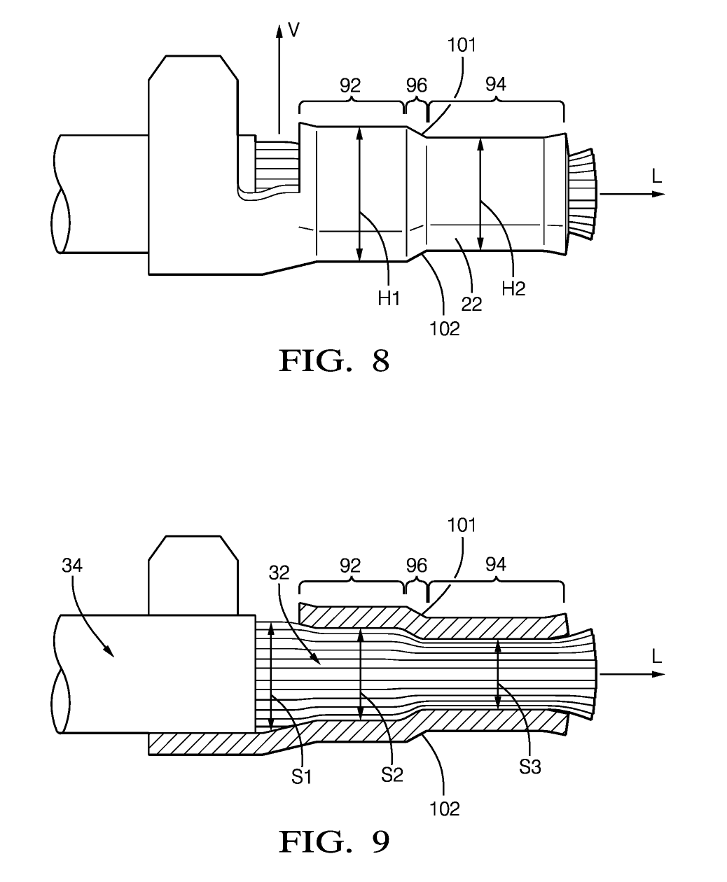

FIG. 8 shows a perspective view of the electrical terminal 10 from FIG. 1 with the coupling portion 12 not shown in order to facilitate the description of this figure. The electrical terminal 10 is shown crimped onto the conductive strands 32 of the electrical cable 30 after a crimping operation carried out with the crimping tool 40 described with reference to FIGS. 2 to 7. After the operation of crimping onto the conductive strands 32 of the part of the electrical cable 30 stripped of insulation 34, that is to say onto the conductive strands 32 of the electrical cable 30, the crimping zone 14 of the electrical terminal 10 features a mechanical retention portion 92, an electrical conduction portion 94 and a transition zone 96 between the two. The mechanical retention portion 92, the electrical conduction portion 94 and the transition zone 96 are in continuity of material with one another, with no slot or cut-out in the longitudinal direction L.

The mechanical retention portion 92 is the portion crimped by the first crimping element 41. In other words, the mechanical retention portion 92 is the portion of the crimping lugs 18, 20 and of the crimping tang 22 that have been crimped onto the conductive strands 32 by the first crimping element 41. The mechanical retention portion 92 is the portion adjacent to the insulation 34 of the electrical cable 30.

The electrical conduction portion 94 is the portion crimped by the second crimping element 43. In other words, the electrical conduction portion 94 is the portion of the crimping lugs 18, 20 and of the crimping tang 22 that have been crimped onto the conductive strands 32 by the second crimping element 43. The electrical conduction portion 94 is the portion adjacent to the coupling portion 12.

The mechanical retention portion 92 and the electrical conduction portion 94 preferably have similar lengths along the longitudinal axis L. The mechanical retention portion 92 and the electrical conduction portion 94 have different crimped heights H1, H2 along the vertical axis V.

The crimped height H1 of the mechanical retention portion 92 is less than the crimped height H2 of the electrical conduction portion 94. The height difference H1−H2 between the mechanical retention portion 92 and the electrical conduction portion 94 forms the transition zone 96. This transition zone 96 has the particular feature of comprising two steps 101, 102: a downward terminal step 101 in the vertical direction perpendicular to the longitudinal axis L from the bent portion of the crimping lugs 18, 20 of the mechanical retention portion 92 to the bent portion of the crimping lugs 18, 20 of the electrical conduction portion 94; and an upward terminal step 102 in the vertical direction perpendicular to the longitudinal axis L from the portion of the crimping tang 22 of the mechanical retention portion 92 to the portion of the crimping tang 22 of the electrical conduction portion 94. These two terminal steps 101, 102 were formed during crimping by the crimping tool 40 comprising an upward anvil step 90 and a downward punch d 75. The two terminal steps 101, 102 are globally aligned along the vertical axis V perpendicular to the longitudinal axis L.

The crimped heights H1, H2 of the mechanical retention portion 92 and the electrical conduction portion 94 are each essentially constant over their respective length. The height difference H1−H2 can generally be of the order of 0.1 to 0.7 mm. For example, the height difference is therefore essentially fixed and may be between 0.5 mm and 0.6 mm inclusive, for a copper sheet thickness between 0.20 mm and 0.39 mm inclusive and for an aluminium cable the diameter of which is between 1.25 mm and 4 mm inclusive, or even between 0.75 mm and 6 mm inclusive.

According to the invention, the crimped height difference H1−H2 between the mechanical retention portion 92 and the electrical conduction portion 94 is divided between the heights of the upward terminal step 102 and the downward terminal step 101. In one particular embodiment, the upward terminal step 102 has a height between 0.4 times and 1.6 times inclusive the height of the downward terminal step 101, preferably between 0.8 times and 1.2 times inclusive. This ratio between the height of the upward terminal step 102 and the downward terminal step 101 is important to guarantee the optimum correct bending between the two crimping lugs 18, 20 onto the conductive strands 32, that is to say bending of the crimping lugs 18, 20 by the crimping tool 40 imparting to them a shape in section in a plane perpendicular to the longitudinal direction L of two arches joined side-by-side by one of their free ends. This solution with two steps 101, 102 makes it possible to guarantee correct bending of the crimping lugs 18, 20 despite a non-zero tolerance clearance between the alignments along a transverse axis T of the first and second punch elements 62, 64 with the first and second anvil elements 51, 53. Without this crimping process with two steps 101, 102, poor alignment of the first and second anvil elements 51, 53 with the first and second punch elements 62, 64 could lead to bending of the crimping lugs 18, 20 with a free end of one of the bent crimping lugs 18 coming to bear on the other bent crimping lug 20. In this situation, there can arise a high risk of galvanic corrosion between the copper electrical terminal 10 and the aluminium conductive strands 32 and therefore of deterioration of the electrical conduction between the electrical terminal 10 and the conductive strands 32.

In FIG. 9, the electrical conduction portion 94 compresses the free end of the conductive strands 32, while the mechanical retention portion 92 compresses the part of the conductive strands 32 adjacent to the insulation 34 of the electrical cable 30. The compression ratio is defined as being the ratio of the section of the electrical cable 30 after crimping to the section S1 of the electrical cable 30 before crimping. It may then be found, on comparing the section of the terminal, and therefore the sections of the electrical cable 30 shown in FIG. 9, that the compression ratio of the electrical cable 30 is greater in the electrical conduction portion 94 than in the mechanical retention portion 92. For example, to obtain a good electrical resistance between the electrical terminal 10 and the conductive strands 32, the compression ratio S3/S1 in the electrical conduction portion 94 is between 45% and 65% inclusive, preferably between 50% and 60% inclusive, and the compression ratio S2/S1 in the mechanical retention portion 92 is between 15% and 40% inclusive, preferably between 20% and 30% inclusive. According to the invention, the compression of the free ends of the conductive strands 32, i.e. the reduction of its section S1, is produced by the compression of the bent portion of the crimping lugs 18, 20 of the electrical conduction portion 94 and by the compression of the portion of the crimping tang 22 of the electrical conduction portion 94 onto the free end of the conductive strands 32. In other words, the reduction of the section S1 of the free end of the conductive strands 32 is distributed in accordance with a reduction obtained by a crimped height H2 of the electrical conduction portion 94 greater than the crimped height H1 of the mechanical retention portion 92 leading to the formation of the upward terminal step 102 and the downward terminal step 101.

1. tool configured for crimping an electrical terminal including a crimping section extending in a longitudinal direction, the said tool comprising:
a crimping punch part provided with a first punch element and a second punch element longitudinally aligned adjacent to the first punch element; and
a crimping anvil part provided with a first crimping anvil element and a second crimping anvil element arranged to face the first punch element and the second punch element;
wherein the first punch element cooperates with the first crimping anvil element forming a first crimping element,
wherein the second punch element cooperates with the second crimping anvil element forming a second crimping element,
wherein the first punch element having comprises a first groove and the second punch element comprises a second groove said first groove longitudinally aligned with said second groove,
wherein the first punch element has a groove depth that is greater than the groove depth of the second punch element, so as to form a downward punch step from the first groove to the second groove; wherein
the first crimping anvil element comprising a first crimping surface and the second crimping anvil element comprising a second crimping surface, said first crimping surface being aligned longitudinally with said second crimping surface, and
wherein the second crimping surface is raised relative to the first crimping surface so as to form an upward anvil step from the first crimping surface to the second crimping surface.

2. The crimping tool according to claim 1, wherein a height of the second crimping element is 10% to 60% less than a height of the first crimping element.

3. The crimping tool according to claim 1, wherein a height of the upward anvil step is between 0.4 times and 1.6 times inclusive a height of the downward punch step.

4. The crimping tool according to claim 3, wherein the height of the downward punch step added to the height of the upward anvil step is between 0.1 mm and 0.7 mm inclusive.

5. A method of crimping an electrical terminal, comprising the steps of:
furnishing an electrical cable comprising insulation and conductive strands;
furnishing the electrical terminal comprising a crimping section extending along a longitudinal axis, said crimping section comprising a longitudinal tang and two lugs each extending from one side of the tang to form a groove having essentially a U-shape in section in a plane perpendicular to a longitudinal direction;
longitudinally positioning the conductive strands of the electrical cable in the crimping section of the electrical terminal;
crimping a mechanical retention portion (92) of the crimping section (14) adjacent to the insulation of the electrical cable; and crimping
crimping an electrical conduction portion of the crimping section by bending and compressing the two lugs onto a free end of the conductive strands and compressing the bottom of the tang onto the free end of the conductive strands, so as to obtain greater compression on the free end of the conductive strands than the compression exerted by the mechanical retention portion on the conductive strands, so as to form a downward terminal step from a bent portion of the two lugs of the mechanical retention portion to the bent portion of the two lugs of the electrical conduction portion, and so as to form an upward terminal step from a portion of the tang of the mechanical retention portion to a portion of the tang of the electrical conduction portion.

6. The method according to claim 5, wherein the steps of crimping the mechanical retention portion and crimping the electrical conduction portion produce a compression ratio in the electrical conduction portion between 45% and 65% inclusive and a compression ratio in the mechanical retention portion between 15% and 40% inclusive.

7. The method according to claim 5, wherein the step of crimping the electrical conduction portion forms the upward terminal step with a height between 0.4 times and 1.6 times inclusive the height of the downward terminal step.

8. The method according to claim 5, wherein the steps of crimping the mechanical retention portion and crimping the electrical conduction portion are performed using a crimping tool having:
a crimping punch part provided with a first punch element and a second punch element longitudinally aligned adjacent to the first punch element; and
a crimping anvil part provided with a first crimping anvil element and a second crimping anvil element arranged to face the first punch element and the second punch element;
wherein the first punch element cooperates with the first crimping anvil element forming a first crimping element,
wherein the second punch element cooperates with the second crimping anvil element forming a second crimping element,
wherein the first punch element comprise a first groove and the second punch element comprises a second groove said first groove longitudinally aligned with said second groove,
wherein the first punch element has a groove depth that is greater than the groove depth of the second punch element, so as to form a downward punch step from the first groove to the second groove, wherein
the first crimping anvil element comprising a first crimping surface and the second crimping anvil element comprising a second crimping surface, said first crimping surface being aligned longitudinally with said second crimping surface, and
wherein the second crimping surface is raised relative to the first crimping surface so as to form an upward anvil step from the first crimping surface to the second crimping surface.

9. An electrical terminal crimped to conductive strands of an electrical cable by a method including the steps of:
furnishing the electrical cable comprising insulation and the conductive strands;
furnishing the electrical terminal comprising a crimping section extending along a longitudinal axis, said crimping section comprising a longitudinal tang and two lugs each extending from one side of the tang to form a groove having essentially a U-shape in section in a plane perpendicular to a longitudinal direction;
longitudinally positioning the conductive strands of the electrical cable in the crimping section of the electrical terminal;
crimping a mechanical retention portion of the crimping section adjacent to the insulation of the electrical cable; and
crimping an electrical conduction portion of the crimping section by bending and compressing the two lugs onto a free end of the conductive strands and compressing the bottom of the tang onto the free end of the conductive strands, so as to obtain greater compression on the free end of the conductive strands than the compression exerted by the mechanical retention portion on the conductive strands, so as to form a downward terminal step from a bent portion of the two lugs of the mechanical retention portion to the bent portion of the two lugs of the electrical conduction portion, and so as to form an upward terminal step from a portion of the tang of the mechanical retention portion to a portion of the tang of the electrical conduction portion,
wherein the bottom of the longitudinal tang comprises the upward terminal step forming a transition between the mechanical retention portion of a crimping zone and the electrical conduction portion of the crimping zone, and
wherein free ends of the two bent lugs of the crimping zone comprise the downward terminal step forming the transition between the mechanical retention portion of the crimping zone and the electrical conduction portion of the crimping zone.

10. The electrical terminal according to claim 9, wherein the upward terminal step has a height between 0.4 times and 1.6 times inclusive the height of the downward terminal step.

11. The electrical terminal according to claim 9, wherein the upward terminal step and the downward terminal step are globally aligned in a vertical direction.

12. The electrical terminal according claim 9, wherein a height of the downward terminal step added to the height of the upward terminal step is between 0.1 mm and 0.7 mm inclusive.

13. The crimping tool according to claim 2, wherein the crimped height of the second crimping element is 30% to 50% less than the crimped height of the first crimping element.

14. The crimping tool according to claim 3, wherein the height of the upward anvil step is between 0.8 times and 1.2 times inclusive the height of the downward punch step.

15. The method according to claim 6, wherein the step of crimping the electrical conduction portion produces the compression ratio in the electrical conduction portion between 50% and 60% inclusive.

16. The method according to claim 6, wherein the step of crimping the mechanical retention portion produces the compression ratio in the mechanical retention portion between 20% and 30% inclusive.

17. The method according to claim 7, wherein the step of crimping the electrical conduction portion forms the upward terminal step with the height between 0.8 times and 1.2 times inclusive the height of the downward terminal step.

18. The electrical terminal according to claim 10, wherein the upward terminal step has the height between 0.8 times and 1.2 times inclusive the height of the downward terminal step.
